(19) United States
(12) Patent Application Publication
(10) Pub. No.: US 2025/0020565 A1
(43) Pub. Date: Jan. 16, 2025

(54) APPARATUS AND METHOD FOR PERMEATION TESTING OF MATERIALS AGAINST CHEMICALS

(71) Applicant: Chairman, Defence Research & Development Organisation (DRDO), New Delhi (IN)

(72) Inventors: Prabhat Garg, Madhya Pradesh (IN); Mohammad Imran, Madhya Pradesh (IN); Vikas Baburao Thakare, Madhya Pradesh (IN); Atul Kumar Sonkar, Madhya Pradesh (IN); Arvind Kumar Gupta, Madhya Pradesh (IN)

(21) Appl. No.: 18/713,407

(22) PCT Filed: Nov. 3, 2022
(86) PCT No.: PCT/IN2022/050968

§ 371 Date: May 24, 2024

(30) Foreign Application Priority Data
Nov. 24, 2021 (IN) 202111054263

(51) Int. Cl. G01N 15/08

(52) U.S. Cl. CPC G01N 15/082

(57) ABSTRACT

The present invention relates to a permeation test cell for permeation testing of materials against chemicals. The permeation test cell comprises an upper body provided with first vents and a lower body provided with second vents, for passing a first and a second gaseous stream. A perforated Polytetrafluoroethylene (PTFE) grid on the sample support plate is placed underneath the test sample to allow passage of the contaminant to the sorbent tube. A test sample with a contaminant is disposed in the permeation test cell. The second vent is configured to be attached to a sorbent tube for accumulation of contaminant permeating through the test sample. The permeation test cell is configured to receive a weight on the test sample for forcing permeation of the contaminant through the test sample.

### CROSS-REFERENCE TO RELATED APPLICATIONS

The present application is a submission under 35 U.S.C. § 371 which claims priority to International Application No. PCT/IN2022/050968, filed Nov. 3, 2022, which claims priority to Indian application Ser. No. 20/211,1054263, filed Nov. 24, 2021, the disclosures of which are incorporated herein by reference in their entireties.

### FIELD OF INVENTION

The present invention herein generally relates to an apparatus and a method for permeation testing of materials and more specifically relates to an apparatus and a method for permeation testing of the materials used for protective ensembles against toxic chemicals especially chemical warfare agents or their simulants.

### BACKGROUND

Toxic chemicals especially chemical warfare agents (CWA) are being used in asymmetric war across the borders or even within the civil population. There is much concern regarding exposure of the CWA to personnel involved in handling these agents or incidents related to exposure of these hazardous chemicals in vapor or liquid form to personnel. Continuous efforts are going on for the advancement in protective ensembles required for individual for protection against the toxic chemicals especially CWA. The functional performance evaluation of these protective ensembles need to be carried out against the chemicals of interest in different modes and configurations.

A number of methodologies exist for measurement of permeation of toxic chemicals. One of the methodologies for measurement of permeation of toxic chemicals especially CWA or their stimulants is the U.S. Army Test Operating Procedure 08-2-501 (TOP). After testing by TOP, the contaminants permeating through a protective material then have to be measured using other conventional techniques. There are various techniques of measurement of quantitative permeation density. The techniques include using chemical agent monitors (CAM) or by desorption of sorbent tube placed at the outlet in the lower body of permeation test cell followed by evaluation by a chromatographic or spectroscopic technique.

TOP specifies the apparatus and protocols for permeation measurements depending upon configuration and mode of permeation. The different modes of permeation include static diffusion mode, dual flow mode and convective flow mode, in line with realistic permeation scenario by effect of air flow. The configurations of permeation include either liquid contamination vapor detection (L/V) or vapor contamination vapor detection (V/V) or liquid contamination liquid detection (L/L) configurations. The configuration of permeation is based on the physical state of chemical for all the aforementioned modes.

FIG. 1A illustrates a schematic diagram of sealed view of a permeation test cell (1), as described in the TOP. FIG. 1B illustrates an unassembled view of the permeation cell (1) for L/V and V/V configuration in static-diffusion and dual-flow modes. FIG. 2A illustrates an unassembled view of permeation test cell (2), as described in the TOP. FIG. 2B illustrates a sealed view of the permeation test cell (2) for L/V and V/V configuration in convective-flow mode, as described in TOP. FIG. 3 illustrates test conditions in L/V configurations, according to TOP and FIG. 4 illustrates test conditions in V/V configurations, according to TOP. One of the drawbacks of TOP is that different apparatus and methodologies are required for evaluation of permeation as per different modes and configurations of permeation operation.

TOP further covers the methodology for permeation testing of protective materials in liquid contamination liquid detection (L/L) configuration using expulsion test mode to evaluate the resistance of protective material against toxic chemical especially CWA or its simulant under external pressure. The expulsion method is important for the protective materials to be evaluated under external pressure in line with realistic scene where a contaminated surface is touched or contaminated object is grasped by the personnel wearing protective gears. As per TOP, there is a difference of contamination density between permeation testing in conventional L/V, V/V and L/L expulsion permeation modes. According to TOP, in L/V configuration with all the three modes, contamination density is 10 g/m² which is administered in the form of 8 or 10 drops (each 1 μL) of single chemical agent on the sample area of 10 cm² while in L/L configuration with qualitative expulsion mode, a single drop of 4 μL (in case of HD) or 5 μL (in case of GA/GB/GD/VX) of single chemical agent is applied to the center of swatch sample. In L/L expulsion mode, the area is defined to be approximately 1.0 in² by the contact region of the weight leading to contamination density approximately 7.75 g/m² with a pressure of 1 psi or 70.2 g/cm². In both the cases, contamination density is sufficiently enough to mimic real scene of permeation.

In expulsion test mode, 1 psi external pressure is applied to material contaminated with single chemical agent drop (5 mg of neat agent or 8 mg of thickened agent). FIG. 5 illustrates an apparatus and methodology of expulsion test. The apparatus consists of a cylindrical stainless-steel weight (10) (454 gms, diameter 2.87 cm) applied on a test sample (14) carrying a chemical agent drop (16). A colorimetric detector paper (12) (M8 chemical agent detector paper) is placed underneath the test sample (14) to determine the breakthrough time. A major drawback of using the TOP methodology is that the evaluation of materials using expulsion method is purely qualitative in nature. Further, the TOP methodology measures breakthrough time in contrast to permeated density of chemical agent.

Therefore, in view of the foregoing limitations, there is a need for an apparatus and a method to enable quantified testing of permeation of contaminants through a protective material in various configurations and modes, representing different environmental controls.

### OBJECTS OF THE INVENTION

A general object of the present invention is to devise an apparatus and a method for permeation testing of protective materials in different modes to enable quantification of the permeation density of the chemical contaminant.

Another objective of the invention is to offer an apparatus and a method for permeation testing instilling high confidence in protective capabilities of the material tested, with low testing costs, and minimum variation in the result of the test of the same sample.

Another objective of the invention is to offer an apparatus and a method for permeation testing to measure the resistance of the materials used in protective ensembles like body suits, gloves, shoes, mask, haversack, cadaver bag etc. against toxic chemicals especially chemical warfare agents or their simulants.

Yet another objective of the present invention is to offer an apparatus and a method for permeation testing by utilizing same apparatus under different configurations and modes to simulate different environmental scenarios affecting permeation of a contaminant through the protective material.

### SUMMARY OF THE INVENTION

The summary is provided to introduce aspects related to an apparatus and method for permeation testing of materials against chemical contaminants, and the aspects are further described below in the detailed description. This summary is not intended to identify essential features of the claimed subject matter nor is it intended for use in determining or limiting the scope of the claimed subject matter.

In order to achieve the above-mentioned objects, according to an aspect of the present invention, a permeation test cell is disclosed. The permeation test cell may be designed to comprise an upper body and a lower body. The upper body may be provided with one or more first vents for passing a first gaseous stream and a lower body may be provided with one or more second vents. A contaminant may be placed on an upper side of a test sample and the test sample may be disposed between the upper body and the lower body. In one aspect of the present invention, the one of the second vents of the lower body may be configured to attach with a sorbent tube to accumulate the contaminant permeated through the test sample. A second gaseous stream may be passed through one of the second vents and released through other one of the second vents, for accumulation of the test sample in the sorbent tube.

In one aspect, the permeation test cell may comprise a sample support plate positioned above the lower body for placement of the test sample and a compression plate positioned below the upper body to hold the test sample in place.

In other aspect, the permeation test cell may comprise a plurality of O-rings positioned in contact with the sample support plate and the compression plate, for prevention of leakage of the contaminant from the edges of the test sample. The first O-ring may be positioned in contact with the compression plate from above and the second O-ring may be positioned in contact with the compression plate from below, and the third O-ring may be positioned in contact with the sample support plate from above and the fourth O-ring may be positioned in contact with the sample support plate from below.

In one embodiment of the present invention, all the first vents may be closed to determine permeability of the contaminant through the test sample in absence of air flow. The second gaseous stream may be supplied across one of the second vents used as an inlet, for release through one of the second vents used as an outlet, to accumulate the contaminant in the sorbent tube.

In one embodiment, the first vent may be closed and the first gaseous stream may be supplied through one of the first vents used as an inlet, for release through one of the first vents used as an outlet, to determine permeability of the contaminant through the test sample when a stream of air flows in line to the test sample. The second gaseous stream may be supplied across one of the second vents used as an inlet, for release through one of the second vents used as an outlet, to accumulate the contaminant in the sorbent tube.

In another embodiment of the present invention, two of the first vents positioned parallelly to each other may be closed and the gaseous stream may be supplied through the other first vent used as an inlet to release through one of the second vents used as an outlet, to accumulate the contaminant in the sorbent tube to determine permeability of the contaminant through the test sample when a stream of air passes across the test sample.

In another embodiment of the present invention, one of the first vent positioned on the top of the upper body may be closed and the first gaseous stream may be supplied and through two of the first vents positioned parallel to each other, to determine permeability of the contaminant through the test sample when a stream of air flows in line to the test sample.

In another embodiment of the present invention, the permeation test cell may comprise a weight positioned on the test sample to impart pressure on the contaminant for forcing permeation of the contaminant through the test sample.

In another embodiment of the present invention, the permeation test cell may comprise a perforated Polytetrafluoroethylene (PTFE) grid placed underneath the test sample to allow passage of the contaminant to the sorbent tube.

In another embodiment of the present invention, the permeation test cell may comprise a first PTFE layer placed between the weight and the test sample, to isolate the contaminant from the weight.

In another embodiment of the present invention, the permeation test cell may comprise a ring of colorimetric detector paper placed between the perforated PTFE grid and the test sample on the periphery of the test sample, for determination of leakage of the contaminant from the edges of the test sample.

In another embodiment of the present invention, the permeation test cell may comprise a second PTFE layer placed between the test sample and the perforated PTFE grid, for blocking permeation of the contaminant through the test sample and determining leakage of the contaminant from the edges of the test sample to the sorbent tube.

These and other aspects of the embodiments herein will be better understood and appreciated when considered in conjunction with the following descriptions and accompanying drawings. It should be considered, however, following descriptions, while indicating preferred embodiments and details thereof are for illustration and not of limitation. Changes and modifications may be made within the scope of embodiments described here without departing from spirit thereof. The embodiments herein include all such modified embodiments.

### BRIEF DESCRIPTIONS OF DRAWINGS

The accompanying drawings are used to provide further understanding of the present invention. Such accompanying drawings illustrate the embodiments of the present invention which are used to describe the principles of the present invention. The embodiments are illustrated by way of example and not by way of limitation in the figures of the accompanying drawings in which like references indicate similar elements. It should be noted that references to “an” or “one” embodiment in this invention are not necessarily to the same embodiment, and they mean at least one. In the drawings:

FIG. 1(A) illustrates a schematic diagram of sealed view of conventional test cell to measure permeation in L/V configuration for dual-flow and static diffusion modes and V/V configuration in dual flow mode, in accordance with the prior art;

FIG. 1(B) illustrates a schematic diagram of unassembled view of conventional test cell to measure permeation in L/V configuration for dual-flow and static diffusion modes and V/V configuration in dual flow mode, in accordance with the prior art;

FIG. 2(A) illustrates a schematic diagram of unassembled view of conventional test cell to measure permeation in L/V and V/V configurations for convective-flow mode, in accordance with the prior art;

FIG. 2(B) illustrates a schematic diagram of sealed view of conventional test cell to measure permeation in L/V and V/V configurations for convective-flow mode, in accordance with the prior art;

FIG. 3 illustrates test conditions in L/V configurations according to TOP, in accordance with the prior art;

FIG. 4 illustrates test conditions in V/V configurations according to TOP, in accordance with the prior art;

FIG. 5 illustrates a schematic diagram of conventional test setup to measure permeation in L/L configuration for expulsion mode, in accordance with the prior art;

FIG. 6(A) illustrates a schematic diagram of sealed view of the permeation test cell, in accordance with an embodiment of the present invention;

FIG. 6(B) illustrates a schematic diagram of unassembled view of the permeation test cell to measure permeation in L/V and V/V configurations for static diffusion, dual flow and convective flow modes, in accordance with an embodiment of the present invention;

FIG. 6(C) illustrates a schematic diagram of sealed view of the permeation test cell in L/V configuration for static diffusion mode, in accordance with an embodiment of the present invention;

FIG. 6(D) illustrates a schematic diagram of sealed view of the permeation test cell in L/V and V/V configurations for dual-flow mode, in accordance with an embodiment of the present invention;

FIG. 6(E) illustrates a schematic diagram of sealed view of the permeation test cell in L/V and V/V configurations for convective flow mode, in accordance with an embodiment of the present invention;

FIGS. 7(A), 7(B), 7(C), and 7(D) illustrate schematic diagrams of the permeation test cell in L/L configuration for quantitative expulsion mode in different implementations, in accordance with embodiments of the present invention;

FIG. 8 illustrates test conditions of quantitative expulsion test, in accordance with an embodiment of the present invention;

FIG. 9 illustrates characteristics of Activated Carbon Sphere (ACS) based three layered composite and Activated Carbon Fabric (ACF) based three layered composite, tested against chemical of interest, in accordance with an embodiment of the present invention;

FIG. 10 illustrates the results of average permeation and standard deviation for a number of replicates of the test sample of ACS and ACF, in accordance with an embodiment of the present invention;

FIG. 11 illustrates the results of average permeation obtained from quantitative expulsion method for a number of replicates of test sample of ACS and ACF, in accordance with an embodiment of the present invention; and

FIG. 12 illustrates a flow diagram illustrating a method for permeation testing of materials against chemicals under pressure, in accordance with an embodiment of the present invention.

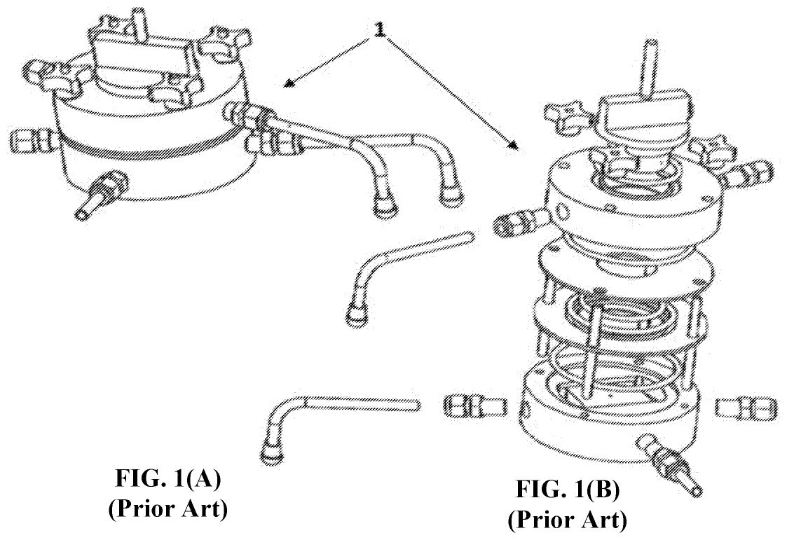

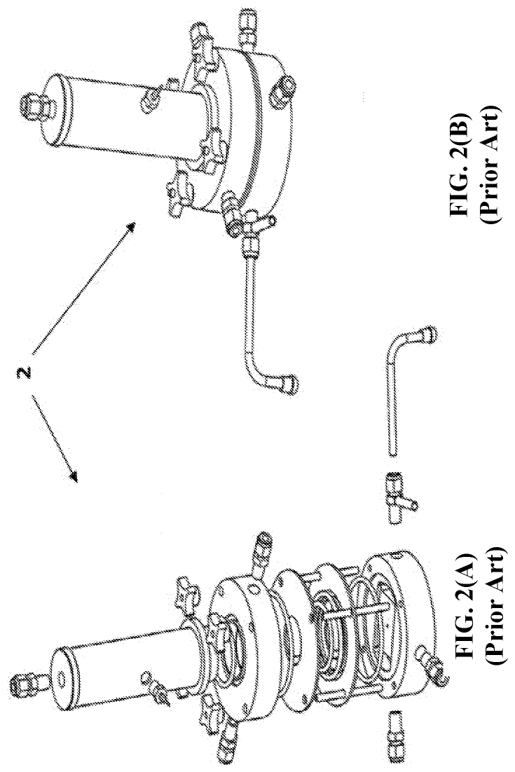

### DETAILED DESCRIPTION OF THE INVENTION

The detailed description set forth below in connection with the appended drawings is intended as a description of various embodiments of the present invention and is not intended to represent the only embodiments in which the present invention may be practiced. The various features of the present invention are explained fully with reference to the non-limiting embodiments. Details of commercial off the shelf and well-known components along with their processes to use have not been included in the embodiments mentioned here to simplify the explanations. The examples given herein should not be construed as limiting the scope of embodiments given herein and are intended to facilitate the understanding of ways in which the embodiments may be practiced by those of skilled in the art.

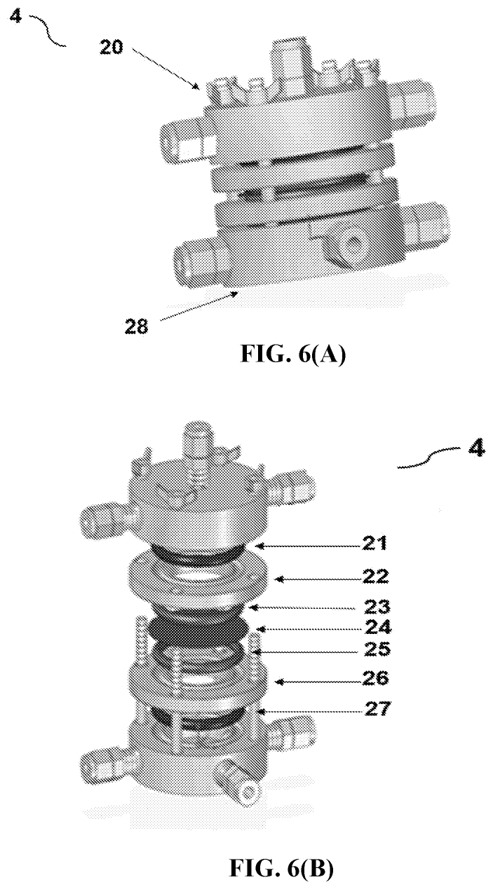

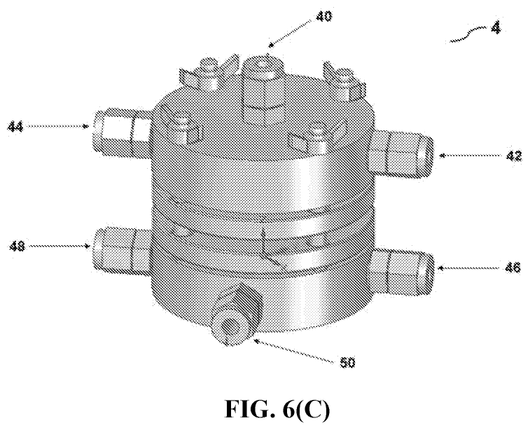

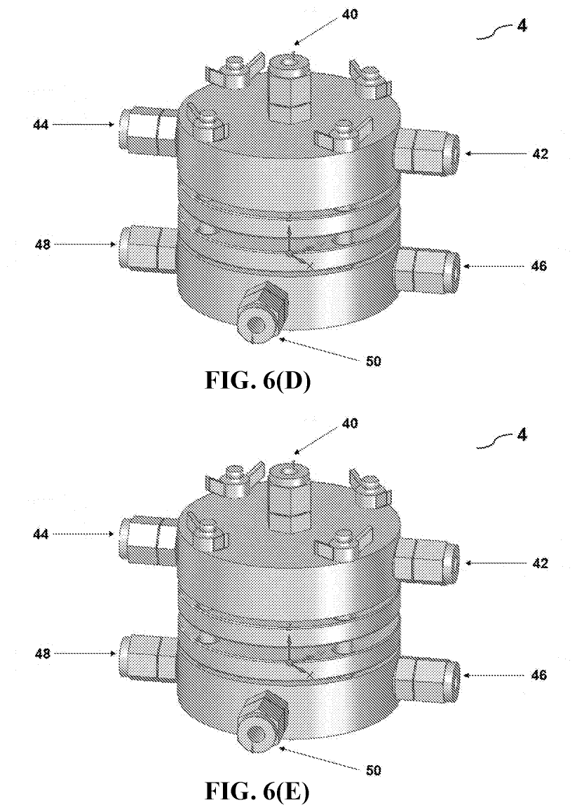

The present invention relates to an apparatus and a method for permeation testing of materials against chemicals in different permeation modes and configurations, to simulate different environmental controls. FIG. 6(A) illustrates a sealed view of a permeation test cell (4). As illustrated in FIG. 6(A), the permeation test cell (4) may comprise an upper body (20) and a lower body (28). The upper body (20) and the lower body (28) may be provided with one or more first vents (40, 42, 44) for passing a first gaseous stream in the upper body (20). The lower body (28) may be provided with one or more second vents (46, 48, 50) for passing a second gaseous stream in the lower body (28).

FIG. 6(B) illustrates an unassembled view of the schematic of the permeation test cell (4). The permeation test cell (4) may comprise a compression plate (22) positioned below the upper body (20) and a sample support plate (26) positioned above the lower body (28). A contaminant (31) may be placed on an upper side of a test sample (24). The test sample (24) may be placed on the sample support plate (26). The test sample (24) is held in place by the compression plate (22). The permeation test cell (4) may further comprise a plurality of O-rings (21, 23, 25, 27) positioned between the upper body (20) and lower body (28). The O-rings may be used for prevention of leakage of the contaminant (31) from the edges of the test sample (24). A first O-ring (21) may be positioned in contact with the compression plate (22) from above. A second O-ring (23) may be positioned in contact with the compression plate (22) from below. A third O-ring (25) may be positioned in contact with the sample support plate (26) from above. A fourth O-ring (27) may be positioned in contact with the sample support plate (26) from below.

Referring back to FIG. 6(A), after placement of the test sample (24) with the contaminant (31) between the upper body (20) and the lower body (28), the upper body (20) and the lower body (28) of the permeation test cell (4) may be sealed with the use of cell lugs. In one implementation, the permeation test cell (4) may be made of stainless steel 316, reducing the chances of corrosion due to use of highly corrosive toxic chemicals especially chemical warfare agents or their simulants.

FIG. 6(C) illustrates a sealed view of the permeation test cell in L/V configuration for static diffusion mode. The first vents (40, 42, 44) of the permeation test cell (4) may be closed to determine permeability of the contaminant (31) through the test sample (24) in absence of air flow. The permeation density of the material may then be quantified for the scenario where air flow does not affect the permeation of the contaminant (31) through the test sample (24).

FIG. 6(D) illustrates a sealed view of the permeation test cell in L/V and V/V configurations for dual-flow mode. The first vent (40) of the permeation test cell (4) may be closed. The first gaseous stream may be supplied through one of the first vents (42, 44) used as an inlet for release through one of the first vents (42, 44) used as an outlet, to determine permeability of the contaminant (31) through the test sample (24) when a stream of air flows in line to the test sample (24). The one of the second vents (50) of the lower body may be configured to attach with a sorbent tube. The sorbent tube accumulates the contaminant (31) permeated through the test sample (24). A second gaseous stream may be supplied across one of the second vents (46, 48) used as an inlet, for release through one of the second vents (46, 48) used as an outlet, to accumulate the contaminant (31) in the sorbent tube. The permeation density of the material may then be quantified for the scenario when air flowing in line with the test sample (24) affects permeation of the contaminant (31).

FIG. 6(E) illustrates a sealed view of the permeation test cell in L/V and V/V configurations for convective flow mode. The first vents (42, 44) of the permeation test cell (4) may be closed. The first gaseous stream may be supplied through the first vent (40) used as an inlet, to determine permeability of the contaminant (31) through the test sample (24) when a stream of air hits against the test sample (24). The one of the second vents (46, 48, 50) of the lower body may be configured to attach with a sorbent tube. The sorbent tube accumulates the contaminant (31) permeated through the test sample (24). The permeation density of the material may then be quantified for the scenario when air flowing across the test sample (24) affects permeation of the contaminant (31).

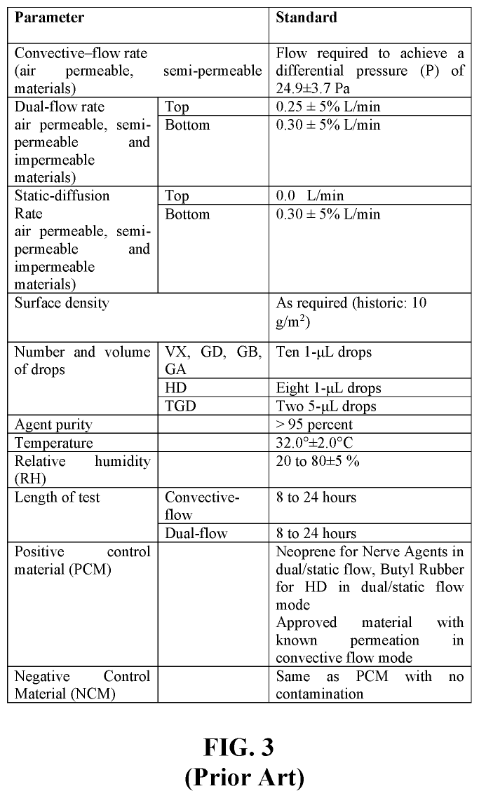

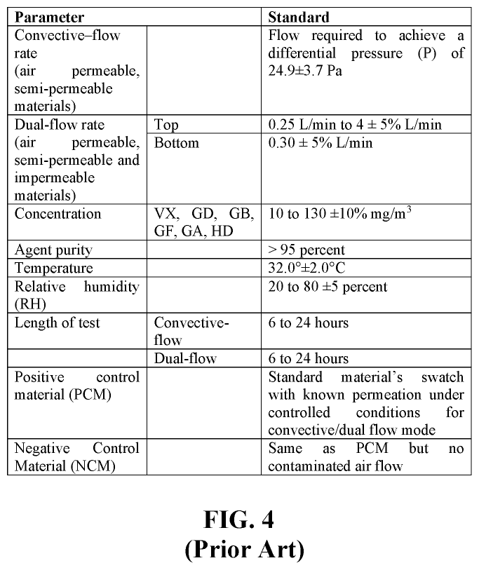

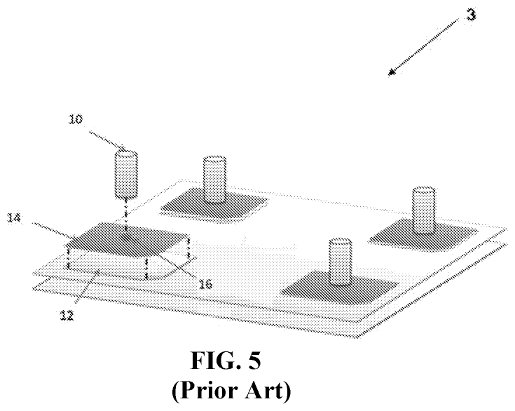

Test parameters described in FIG. 3 and FIG. 4 as per TOP, may similarly be used in different configurations for various modes of the present invention as illustrated in FIG. 6(C), 6(D) and 6(E). The contamination densities may also be maintained similar to the contamination densities in conventional TOP. Additionally, the contamination density may be varied as per the requirement of permeation test conditions.

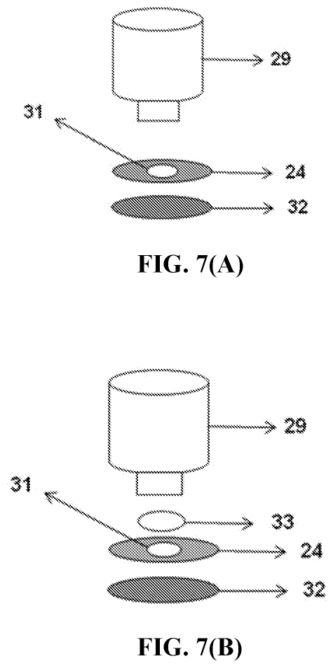

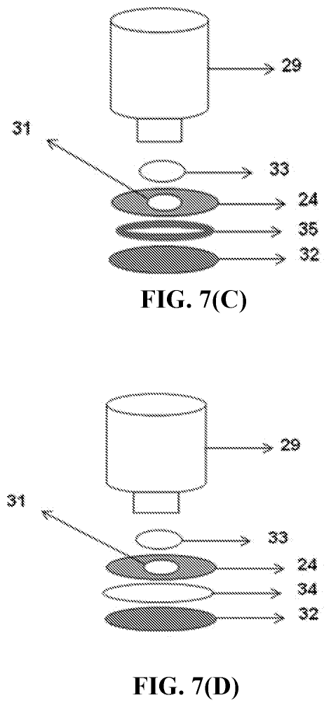

The permeation test cell (4) may be used in quantitative expulsion mode to measure permeation under the effect of external pressure. FIG. 7(A), 7(B), 7(C), and 7(D) illustrate the permeation test cell in L/L configuration for quantitative expulsion mode in different implementations. For use in expulsion mode, the permeation test cell (4) may comprise of a weight (29) placed on the contamination (31) present on the test sample (24). The weight (29) imparts pressure on the contaminant (31) for forcing permeation of the contaminant (31) through the test sample (24). The weight may be made of stainless steel grade 316 for reducing the chances of corrosion due to use of highly corrosive toxic chemicals especially chemical warfare agents or their simulants.

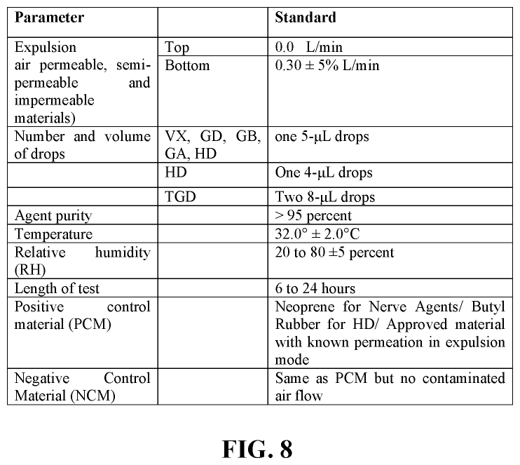

As illustrated in FIG. 7(A), the permeation test cell (4) may comprise a perforated Polytetrafluoroethylene (PTFE) grid (32) placed underneath the test sample (24). The perforated PTFE grid allows passage of the contaminant (31) to the sorbent tube. The weight made of stainless steel (29) may be placed over the test sample (24) to impart the external pressure on the contaminated protective material. The permeation cell (4) may be sealed and permeation of the contamination may be allowed in liquid contamination vapor detection (L/V) configuration for quantitative expulsion mode. The vapors of permeated contaminant swept by stream of dry air in lower body may adsorb in sorbent tube attached to one of the second vents (50) of lower body. Quantitative determination of permeation may be measured by desorption of contaminant from sorbent material inside the sorbent tube using a solvent and may be analyzed using chromatographic or any other quantitation technique. FIG. 8 illustrates the test conditions of quantitative expulsion test.

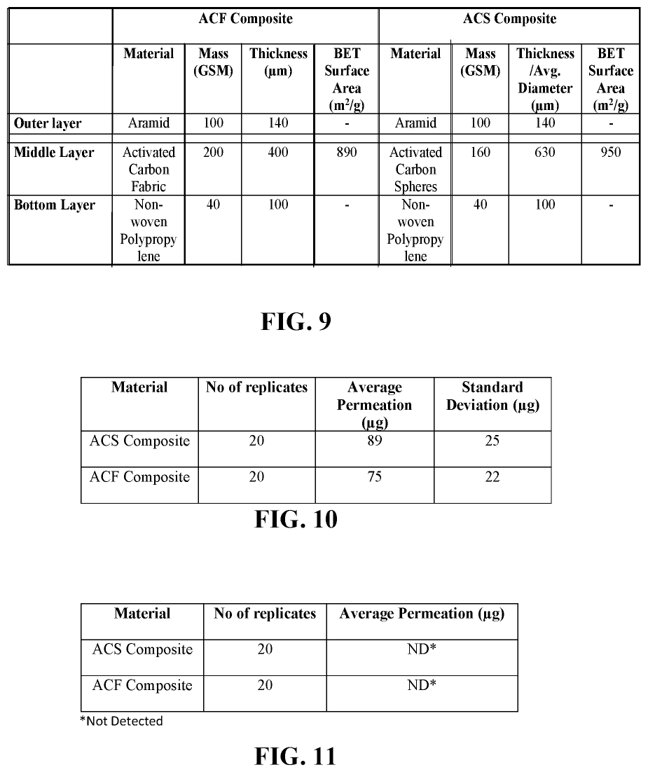

Some of the test methods performed for measuring the permeation of contaminants through materials are described below in non-limiting examples. FIG. 9 illustrates testing of two materials, an Activated Carbon Sphere (ACS) based three layered composite and an Activated Carbon Fabric (ACF) based three layered composite, against one compound of interest, Sarin (GB), a CWA. The permeation test was carried for six hours. More than 20 replicates were tested for each composite, as well as minimum 10 control samples were tested. The test method used was based on the developed quantitative expulsion test in L/V configuration as described above. The test parameters mentioned in FIG. 8 were utilized. FIG. 10 illustrates the results of average permeation and standard deviation for the test samples tested. It was observed that the Standard deviation (SD) of the permeated amount of contamination is large especially with ACS composite which may be due to non-uniformity in the replicate test samples. It is apparent that the present invention provides improvements to the conventional test methods to enable quantification of permeated amount.

There exists a possibility that the contaminant (31) instead of passing through test sample (24), travels through the edges of the test sample (24) and reaches the lower body (28) despite of O-ring tightening on the edges. This leakage defeats the test method. To rule out this situation, integrity of the permeation test cell (4) may be checked to ensure that there is no leakage of contaminant (31) through edges of the test sample (24) in the sorbent tube.

As illustrated in FIG. 7(B), the permeation test cell (4) may comprise a first PTFE layer (33) placed between the weight (29) and the test sample (24). The first PTFE layer (33) isolates the contaminant (31) from the weight (29). The first PTFE layer (33) prevents any chemical reaction between the weight (29) and the contaminant (31). The first PTFE layer (33) may also uniformly spread the contaminant (31) on the test sample (24).

As illustrated in FIG. 7(C), a ring of colorimetric detector paper (35) may be placed between the perforated PTFE grid (32) and the test sample (24). The colorimetric detector paper (35) may be placed on the periphery of the test sample (24). The colorimetric detector paper determines leakage of the contaminant (31) from the edges of the test sample (24). If contamination is passed through edges instead of passing through swatch sample, this colorimetric paper changes its color.

Further, to establish integrity of the permeation test cell (4), that for the given contaminant and protective material combination, contaminant permeates through the test sample (24) and not through the edges of the test material (24), characterization samples may be included before every batch of test sample. The purpose of these characterization samples may be used to demonstrate that the contaminant (31) does not wick through the edges of the test sample (24). As illustrated in FIG. 7(D), the permeation test cell (4) may comprise a second PTFE layer (34). The second PTFE layer (34) may be placed between the test sample (24) and the perforated PTFE grid (32). The second PTFE layer (34) may block permeation of the contaminant (31) through the test sample (24) and may determine leakage of the contaminant (31) from the edges of the test sample (24) to the sorbent tube. If any contamination is measured in the sorbent tube, test is defeated for the combination of material and contaminant.

Various quality controls were incorporated into the testing protocols of permeation testing including purity analyses of contamination, efficiency of sorbent tube, positive control samples, negative control samples, verification of contamination quantity, testing leakage through edges of test sample and analytical control. The quality controls are further described below in non-limiting examples.

The swatches were cut with sharp edged steel die and press. For the protective body suit, an equal number of swatches are taken from front, back, arms and legs. Gas tight syringe may be used for spiking the liquid contaminant onto the sample swatch. A calibrated balance may be used for the verification of the weight of spiked contaminant. Solvents used in the testing were of chromatography grade.

As a part of quality control of the system, the efficiency of Fluka make ORBO™ 609 Amberlite® XAD®-2 (20/50) 400/200 mg sorbent tube was determined. For determining efficiency of sorbent tube with respect to particular chemical, solution of 5 μg, 10 μg, 100 μg, 500 μg and 5 mg of the chemical in 100 μL solvent was spiked onto the sorbent material in the sorbent tube separately. A larger area of the sorbent tube got wet. The total mass adsorbed fit within the calibration curve of analytical instrument and was within the range of concentrations in which the sorbent tube is expected to perform. A stream of dry air with the velocity of 300 mL/min was passed through the sorbent tube for 6 hours at approximately 32° C. After 6 hours, sorbent material was taken from sorbent tube and extracted with 20 mL of ethyl acetate for approximately 30 minutes and quantitative determination is carried out by fitting the data into calibration curve based on the standard solutions of the chemical. Other solvents may be used, as appropriate for the particular contaminants and/or analytical technique. The extractant was analyzed with gas chromatography-mass spectrometer (GC-MS) (not shown) having quantification limit of approximately 1 μg/mL. Improved limit of detection may be achieved using other analytical tools.

Another quality control parameter is purity of the contaminant. The use of low purity contaminant may lead to incorrect results. In another embodiment of the present invention, the purity of the contaminant may be checked using analytical technique such as Nuclear Magnetic Resonance (NMR) Spectroscopy (not shown).

In another implementation of the present invention, the repeatability of gas tight syringe may be checked using gravimetric method. The target amount taken into gas tight syringe may be weighed accurately by taking into a vial using calibrated electronic balance (not shown) and variance may be recorded.

In another implementation of the present invention, the temperature of the incubator (not shown) may be set to approximate at 32° C. or any other desired value and verified using a calibrated temperature recorder (not shown). The stainless-steel permeation test assembly may be allowed to equilibrate for at least 24 hours prior to each test. Temperature may be recorded every minute to note the variance. Other temperature may be used as required by test conditions.

Positive control sample may be required before or simultaneously with testing the actual sample. The purpose of positive control sample is to ensure the performance of testing methodology and apparatus used. Butyl rubber/material with known permeation density in case of HD and neoprene/material with known permeation density for nerve agents (GB, GD, GA, VX) in the controlled conditions may be taken as positive control sample.

Negative control sample may also be required to run before or simultaneously with the actual sample. Negative control sample could be the same as positive control sample but without any contamination. The purpose of negative control is to demonstrate the proper working of test apparatus and methodology and also to demonstrate that there is no cross contamination which could occur from tools or other test cells. Contaminants are not measured above the quantification limit for any of the negative control samples.

The analytical methods used herein include a calibration curve prepared by quality check samples to increase the confidence in the data. The limit of quantitation is measured by the standard sample of lowest concentration in the calibration curve. The calibration curve should be linear with value of R² ranging from 0.995 to 0.999.

In another implementation of the present invention, to assess the upper limit for bias and account for sample loss due to interaction of contaminant with the first PTFE layer (33), the second PTFE layer (34), and the perforated PTFE grid (32). The second PTFE layer (34) may be spiked with the contamination and placed over the PTFE perforated grid (32). Contaminants may be covered with the first PTFE layer (33) and the weight (29) may be placed over it. The sample follows the same test process but without sorbent tube or stream of air. After certain duration, both the PTFE layers (33, 34) and the perforated PTFE grid (32) may be extracted independently and sample loss may be checked by comparing the extracted quantity of contaminant with the original contaminant amount. The sum of both the PTFE layers (33, 34) and the perforated PTFE grid (32) extraction results is expected to be equal to the original contamination level. The difference is attributed to potential loss during the entire process.

In the second round of testing, permeation of 5 mg VX was measured through three layered ACS and three layered ACF composites as illustrated in FIG. 9. Using the quantitative expulsion methodology described above, measurement of permeation amount was calculated. Permeation in samples below the quantification limit or not detected in analyses are marked “ND”. For each of these tests, the sorbent tubes were extracted in solvent for 30 minutes followed by GC-MS studies. FIG. 11 illustrates the results of average permeation obtained from quantitative expulsion method for a number of replicates of test sample of ACS and ACF.

The present invention may be used for permeation through any of air impermeable, semi permeable and air permeable protective materials. The implementation of the present permeation test method with different accessories increases the confidence of protective capabilities of materials and reduces operational testing costs by using same apparatus under different quantitative measurement configurations and modes. The method and apparatus also evaluate performance under conditions that reflect more realistic use in different environmental scenarios, such as mimicking forces associated with touching a contaminated surface or grasping a contaminated object. The present invention provides a quantitative expulsion test method to indicate that the material may provide suitable protection for approximately 6 hours under external pressure.

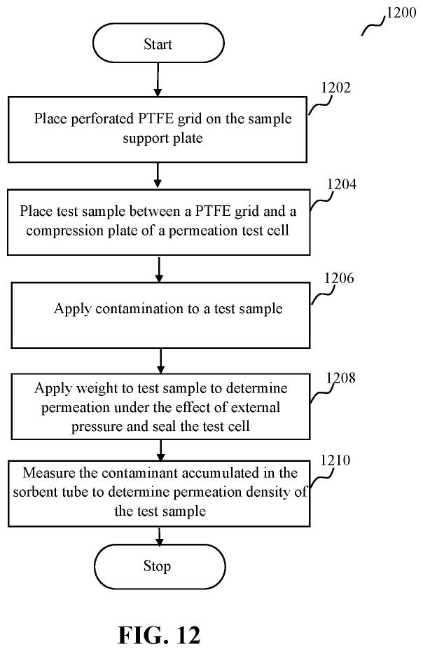

Referring now to FIG. 12, a method for permeation testing of materials against chemicals under the effect of pressure is described, with reference to a flowchart 1200. The flowchart describes the method of permeation testing of contaminant in liquid contamination vapor detection (L/V) configuration for quantitative expulsion mode, in accordance with an embodiment of the present invention. It should be noted that in some alternative implementations, the steps may occur out of the order or maybe executed substantially concurrently or may be modified to execute the method combining other components of the invention, depending upon the embodiments of the present invention.

At block 1202, to initiate the permeation testing of a test sample in a permeation test cell, a perforated PTFE grid may be placed on the sample support plate for allowing passage of the contaminant permeating through the test sample to the sorbent tube attached in the lower body. At block 1204, the test sample may be securely placed in the permeation test cell. The test sample may be placed on a perforated PTFE grid on sample support plate. At block 1206, contamination may be applied onto the test sample which may be held in place by a compression plate above the test sample. The contaminant may be present in liquid form., At block 1208, a weight is applied onto the test sample for imparting pressure and determination of effect of external pressure in permeation of the contaminant through the test sample and test cell may be sealed. At block 1210, the contaminant permeating through the test sample may be accumulated in the sorbent tube and measured using chromatographic technique for quantitative determination of the permeation density of the test sample.

The detailed description set forth above in connection with the appended drawings is intended as a description of various embodiments of the present disclosure and is not intended to represent the only embodiments in which the present disclosure may be practiced. Each embodiment described in this disclosure is provided merely as an example or illustration of the present disclosure, and should not necessarily be construed as preferred or advantageous over other embodiments.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application. in the specific form in which such claims issue, including any subsequent correction.

1. A permeation test cell for testing permeation of chemical contaminants through a material, the permeation test cell comprising:
an upper body provided with one or more first vents for passing a first gaseous stream and a lower body provided with one or more second vents for passing a second gaseous stream, wherein the upper body and the lower body are sealed together after placing a contaminant on an upper side of a test sample placed between the upper body and the lower body; and
one of the second vents of the lower body being configured to attach with a sorbent tube to accumulate the contaminant permeated through the test sample,
wherein the apparatus is configured to receive:
a weight on the test sample to impart pressure on the contaminant for forcing permeation of the contaminant through the test sample; and
a perforated Polytetrafluoroethylene (PTFE) grid placed underneath the test sample to allow passage of the contaminant to the sorbent tube.

2. The permeation test cell as claimed in claim 1, comprises a compression plate positioned below the upper body and a sample support plate positioned above the lower body, wherein the test sample is disposed between the sample support plate and the compression plate.

3. The permeation test cell as claimed in claim 1, comprises a plurality of O-rings positioned in contact with the sample support plate and the compression plate, wherein the plurality of O-rings prevents leakage of the contaminant from the edges of the test sample.

4. The permeation test cell as claimed in claim 3, wherein the first O-ring is positioned in contact with the compression plate from above and the second O-ring is positioned in contact with the compression plate from below, and the third O-ring is positioned in contact with the sample support plate from above and the fourth O-ring is positioned in contact with the sample support plate from below.

5. The permeation test cell as claimed in claim 1 through claim 4, wherein all the first vents are closed to determine permeability of the contaminant through the test sample in absence of air flow and wherein the second gaseous stream is supplied across one of the second vents used as an inlet, for release through one of the second vents used as an outlet, to accumulate the contaminant in the sorbent tube.

6. The permeation test cell as claimed in claim 1 through claim 4, wherein the first vent is closed and the first gaseous stream is supplied through one of the first vents used as an inlet, for release through one of the first vents used as an outlet, to determine permeability of the contaminant through the test sample when a stream of air flows in line to the test sample.

7. The permeation test as claimed in claim 1 through claim 4, wherein the first vents are closed and the first gaseous stream is supplied through the first vent used as an inlet to release through one of the second vents used as an outlet, to accumulate the contaminant in the sorbent tube to determine permeability of the contaminant through the test sample when a stream of air passes across the test sample.

8. The permeation test cell as claimed in claim 1, through claim 4, comprises a weight placed on the contamination on test sample to impart stress on the contamination to permeate.

9. The permeation test cell as claimed in claim 1 and claim 8, comprises a first PTFE layer placed between the weight and the test sample, to isolate the contaminant from the weight.

10. The permeation test cell as claimed in claim 1 and claim 9, comprises a ring of colorimetric detector paper placed between the perforated PTFE grid and the test sample on the periphery of the test sample, wherein the colorimetric detector paper determines leakage of the contaminant from the edges of the test sample.

11. The permeation test cell as claimed in claim 1 and claim 9, comprises a second PTFE layer placed between the test sample and the perforated PTFE grid, wherein the second PTFE layer blocks permeation of the contaminant through the test sample and determines leakage of the contaminant from the edges of the test sample to the sorbent tube.

12. A method for testing permeation of chemical contaminations through a material, the method comprising:
providing a permeation test cell comprised of an upper body with one or more first vents for passing a first gaseous stream and a lower body with one or more second vents for passing a second gaseous stream;
providing a sample support plate above the lower body for placement of the test sample and a compression plate below the upper body for holding test sample in place;
disposing the test sample between the sample support plate and the compression plate;
applying a contaminant on the upper side of a test sample;
attaching a sorbent tube to the second vent for accumulation of the contaminant permeated through the test sample; and
sealing the upper body of the test cell with the lower body.

13. The method as claimed in claim 12, comprising providing a plurality of O-rings for prevention of leakage of the contaminant from the edges of the test sample.

14. The method as claimed in claim 12 and claim 13, comprising positioning the first O-ring in contact with the compression plate from above and positioning the second O-ring in contact with the compression plate from below, and positioning the third O-ring in contact with the sample support plate from above and positioning the fourth O-ring in contact with the sample support plate from below.

15. The method as claimed in claim 12 through claim 13, comprising closing all the first vents for determination of permeability of the contaminant through the test sample in absence of air flow and supplying a second gaseous stream from one of the second vents used as an inlet, for release through one of the second vents of the lower body.

16. The method as claimed in claim 12 through claim 13, comprising closing the first vent and supplying the first gaseous stream through one of the first vents used as an inlet and releasing the first gaseous stream through one of the first vents used as an outlet, for determination of permeability of the contaminant through the test sample when a stream of air flows in line to the test sample.

17. The method as claimed in claim 12 through claim 13, comprising closing the first vents and supplying the first gaseous stream through the first vent used as an inlet to release through one of the second vents used as an outlet, to accumulate the contaminant in the sorbent tube for determination of permeability of the contaminant through the test sample when a stream of air passes across the test sample.

18. The method as claimed in claim 12 through claim 13, comprising positioning a perforated Polytetrafluoroethylene (PTFE) grid underneath the test sample to allow passage of the contaminant to the sorbent tube.

19. The method as claimed in claim 12 through claim 13, comprising positioning a weight on the test sample to impart pressure on the contaminant for forcing permeation of the contaminant through the test sample.

20. The method as claimed in claim 15, comprising positioning a first PTFE layer between the weight and test sample to isolate the contaminant from the weight.

21. The method as claimed in claim 15, comprising positioning a ring of colorimetric detector paper between the perforated PTFE grid and the test sample on the periphery of the test sample, for determination of leakage of the contaminant from the edges of the test sample.

22. The method as claimed in claim 15, comprising positioning a second PTFE layer between the test sample and the perforated PTFE grid, for blocking permeation of the contaminant through the test sample and determination of leakage of the contaminant from the edges of the test sample to the sorbent tube.
